(19) United States
(12) Patent Application Publication
(10) Pub. No.: US 2025/0242317 A1
(43) Pub. Date: Jul. 31, 2025

(54) SYSTEMS AND METHODS FOR SENSING THE STATUS OF A SAMPLE DURING MIXING

(71) Applicant: Saudi Arabian Oil Company, Dhahran (SA)

(72) Inventors: Mohammed Abdullah AlGhamdi, Dammam (SA); Faisal Fayez AlMalki, Dhahran (SA)

(73) Assignee: Saudi Arabian Oil Company, Dhahran (SA)

(21) Appl. No.: 18/427,554

(22) Filed: Jan. 30, 2024

(51) Int. Cl. B01F 35/214; B01F 33/25; B01F 35/21; B01F 101/23; G01N 1/38

(52) U.S. Cl. CPC B01F 35/2142; B01F 33/251; B01F 35/2113; B01F 35/2115; G01N 1/38; B01F 2101/23; G01N 2001/386

(57) ABSTRACT

Sample processing methods and apparatus are discussed. In some cases, apparatus are discussed that include: a mixing element having a first volume and a mixing chamber. The first mixing volume comprises: a sealed first housing having a first interior region, a sensor set disposed in the first interior region and configured to sense a set of characteristics of the mixing element, and a wireless transmitter disposed in the first interior region and configured to communicate the set of characteristics. The mixing chamber comprises a liquid port and a second housing having a second interior region. The mixing element is disposed in the second interior region having a second volume, and the liquid port configured to transmit the liquid into the second interior region.

### BACKGROUND

Laboratory processes often involve careful mixing of liquids using a mixing chamber equipped with a mixing ball. In operation, the mixing chamber is subjected to a periodic movement causing the mixing ball within the mixing chamber to move within. This movement of the mixing ball causes a mixing of liquids within the mixing chamber. An ability to measure characteristics of liquid in the mixing chamber while mixing is underway is limited.

Hence, there is a need in the art for methods and systems for improving the accuracy of measurements within a mixing chamber.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Various embodiments provide sample mixing apparatus. In some cases, the apparatus include: a mixing element having a first volume and a mixing chamber. The first mixing volume comprises: a sealed first housing having a first interior region, a sensor set disposed in the first interior region and configured to sense a set of characteristics of the mixing element, and a wireless transmitter disposed in the first interior region and configured to communicate the set of characteristics. The mixing chamber comprises a liquid port and a second housing having a second interior region. The mixing element is disposed in the second interior region having a second volume, and the liquid port configured to transmit the liquid into the second interior region. The second volume is greater than the first volume.

Some other embodiments provide methods for processing a liquid. The methods may include: introducing a liquid into a second interior region of a second housing via a liquid port, where a mixing element is deployed within the second interior region. The mixing element includes: a first housing surrounding a first interior region; a sensor set disposed in the interior region and configured to sense a set of characteristics of a liquid adjacent the first housing, and a wireless transmitter configured to communicate the set of characteristics. Such methods may further include moving the second housing to cause the first housing to move within the second interior region mixing the liquid; sensing, by the sensor set, a set of characteristics of the liquid surrounding; and transmitting, by the wireless transmitter; the set of characteristics.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a mixing device including a mixing element having various sensors in accordance with one or more embodiments.

FIGS. 2A-2B show a mixing element including sensor and transmission circuitry in accordance with various embodiments.

FIG. 3 is a flow diagram showing a method in accordance with some embodiments for monitoring one or more characteristics of a mixing element within a mixing device where the mixing element is moved through a liquid being mixed.

FIG. 4 is a flow diagram showing a method in accordance with various embodiments for processing data received from a mixing element within a mixing device while a liquid is being mixed in the mixing device.

FIG. 5 is a flow diagram showing a method in accordance with some embodiments for configuring a mixing element within a mixing device from the perspective of a control system or receiving device external to the mixing device.

FIG. 6 is a flow diagram showing a method in accordance with some embodiments for configuring a mixing element within a mixing device from the perspective of the mixing element.

FIG. 7 shows a computer system that may be used in relation to one or more embodiments.

### DETAILED DESCRIPTION

Various embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Various embodiments provide for a mixing element having at least a sensor set and a transmitter incorporated within the mixing element. The mixing element may be deployed within a mixing chamber of a mixing device where it moves in relation to the mixing chamber to mix a liquid within the mixing chamber. The sensor set senses one or more characteristics of the mixing element within the mixing chamber, and the sensed characteristics are wirelessly transmitted to a receiving device disposed outside of the mixing chamber. As the mixing element is surrounded by the liquid in the mixing device, the characteristics of the mixing element are reasonably representative of corresponding characteristics of the liquid.

Having a mixing element with a sensor set disposed within the mixing element provides an ability to accurately sense characteristics of a liquid within the mixing chamber that surrounds the mixing element. Such a mixing element disposed within a mixing chamber allows, for example, the temperature of the liquid within the mixing chamber to be measured. This measurement may be done in, for example, high pressure and/or temperature environments and results in an accurate representation of the temperature of a homogeneous mixture of liquids within the mixing chamber.

In some embodiments, the mixing element includes a sealed first housing having a first interior region. In some cases, the first housing is a metal housing. Based upon the disclosure provided herein, one of ordinary skill in the art will recognize a variety of different materials that may be used to form the first housing. In various cases, the housing is a spherical ball. The sensor set is disposed in the first interior region and is configured to sense a set of characteristics of a liquid adjacent to the first housing. A wireless transmitter is also disposed in the first interior region and is configured to communicate the set of characteristics to a receiving device external to the mixing chamber. The set of sensors include at least one sensor and may include any number of sensors. The set of sensors may include, but are not limited to, at least one of a temperature sensor and/or a movement sensor. The set of characteristics include at least one characteristic and may include any number of characteristics. The set of characteristics may include, but are not limited to, at least one of a temperature of the liquid within the mixing chamber and/or an acceleration of the mixing element.

The mixing chamber includes a second housing having a second interior region. In some cases, the second housing is a metal housing. Based upon the disclosure provided herein, one of ordinary skill in the art will recognize a variety of different materials that may be used to form the second housing. The second interior region provides a volume in which liquid may be inserted and mixed. The second volume is greater than the first volume of the mixing element. The mixing element is disposed within the second interior region. The mixing chamber further includes a liquid port via which liquid may be moved in and out of the mixing chamber.

In operation, one or more liquids may be inserted into the second interior region of the mixing chamber via the liquid port. The liquid port is then sealed to maintain the liquid(s) within the mixing chamber. A pressure of the liquid within the mixing chamber may then be controlled by injecting a gas into a gas chamber adjacent to the mixing chamber and separated by a movable piston that seals the first interior region from the second interior region. Further, a temperature of the liquid within the mixing chamber may be controlled by heating the mixing chamber using a heater.

The liquid(s) within the mixing chamber are subjected to a mixing process that includes moving the mixing chamber in a way that causes the mixing element within the mixing chamber to move relative to the mixing chamber and/or the liquid within the mixing chamber. Movement of the mixing element relative to the liquid within the mixing chamber results in a mixing force applied to the liquid(s). In some cases, the mixing results in a homogeneous mixture within the mixing chamber.

While the mixing process is ongoing, one or more characteristics of the liquid(s) and/or the mixing element are sensed. In some embodiments, this may include sensing a temperature within the mixing element which corresponds to the temperature of the liquid(s) surrounding the mixing element within the mixing chamber, and/or sensing an acceleration of the mixing element within the mixing chamber. These sensed characteristics are transmitted to a receiving device external to the mixing chamber via a wireless communication link.

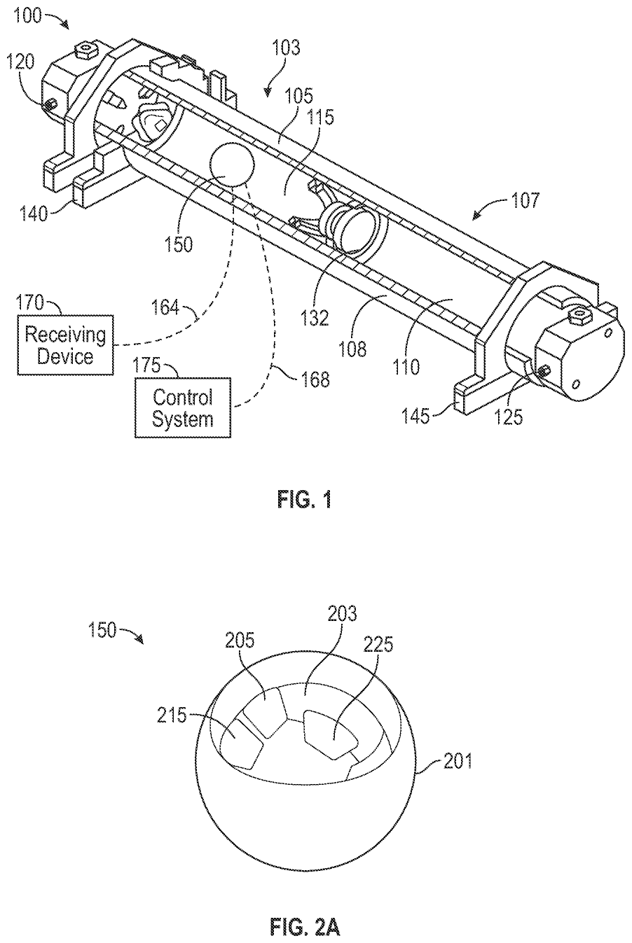

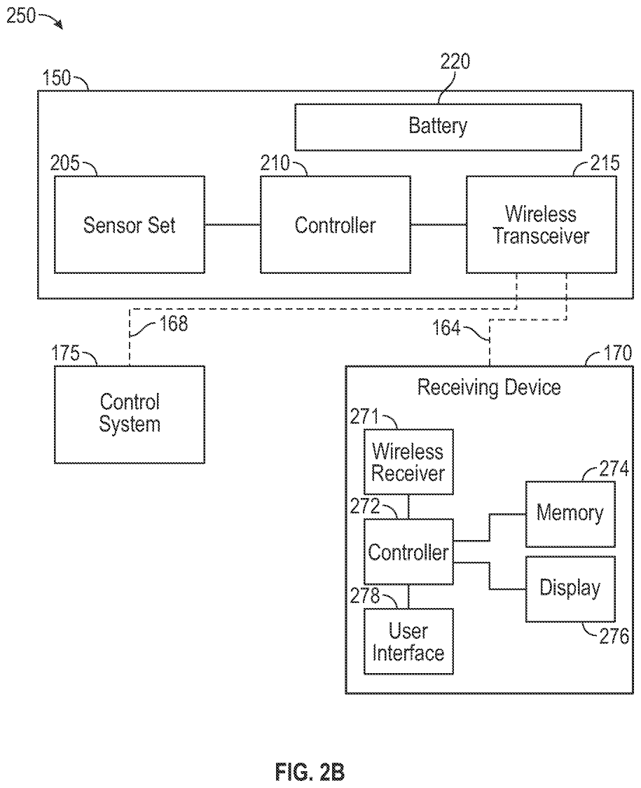

Turning to FIG. 1, a mixing device 100 including a mixing element 150 is shown in accordance with one or more embodiments. Mixing element 150 includes a sensor set discussed below in relation to FIGS. 2A-2B that are configured to sense characteristics of mixing element 150 as it moves in a mixing motion within mixing device 100. The set of sensors include at least one sensor and may include any number of sensors. The set of sensors may include, but are not limited to, at least one of a temperature sensor and/or a movement sensor. The set of characteristics include at least one characteristic and may include any number of characteristics. The set of characteristics may include, but are not limited to, at least one of a temperature of the liquid within the mixing chamber and/or an acceleration of the mixing element. In some embodiments, mixing element 150 is a spherical ball.

Mixing device 100 includes a mixing chamber 103 having a housing 105 and an interior region 115. In some embodiments, housing 105 housing is a metal housing. Based upon the disclosure provided herein, one of ordinary skill in the art will recognize a variety of different materials that may be used to form housing 105. In addition, mixing device 100 includes a gas chamber 107 having a housing 108 and an interior region 110. In some embodiments, housing 108 housing is a metal housing. Based upon the disclosure provided herein, one of ordinary skill in the art will recognize a variety of different materials that may be used to form housing 108. In various embodiments, housing 105 and housing 108 are a continuous housing, and interior region 115 and interior region 110 are a continuous region separated by a movable piston 132. Movable piston 132 seals interior region 115 from interior region 110 such that a gas in gas chamber 107 does not mix with a liquid in mixing chamber 103.

In some embodiments, interior region 115 is cylindrical in shape. Based upon the disclosure provided herein, one of ordinary skill in the art will recognize a variety of shapes of interior region 115 that may be used in relation to different embodiments. In some such embodiments, mixing element 150 is a spherical shape with a volume that is less than eighty (80) percent of the volume of interior region 115.

Mixing device 100 further includes a liquid port 120 and a gas port 125. Liquid port 120 is fluidically coupled to interior region 115 and provides for transfer of liquids into and out of interior region 115. Further, liquid port 120 is sealable such that when a liquid in interior region 115 is being heated, pressurized, and/or mixed within interior region 115, the liquid is precluded from exiting interior region 115 via liquid port 120.

Gas port 125 is fluidically coupled to interior region 110 and provides for transfer of gases into and out of interior region 110. Further, gas port 125 is sealable such that when a gas in interior region 110 is being heated and/or pressurized within interior region 110, the gas is stopped from exiting interior region 110 via gas port 125. In operation, a gas may be forced into interior region 110 via gas port 125 at a defined pressure which increases the pressure within interior region 110. As the pressure within interior region 110 is increased, movable piston 132 moves toward interior region 115 effectively increasing the volume of interior region 110 and decreasing the volume of interior region 115. This continues until any gas within interior region 115 is expelled through liquid port 120 leaving only liquid. Liquid port 120 is sealed and the pressure within interior region 115 is increased to a desired pressure. As movable piston 132 is movable, the pressure within interior region 110 is translated to interior region 115.

Mixing device 100 additionally includes brackets 140, 145 that are configured to attach with a rocking device (not shown). The rocking device causes mixing device 100 including housing 105 to move. This movement of mixing device 100 causes mixing element 150 to move within interior region 115 and mixing any liquid within mixing chamber 103. As mixing element 150 moves within interior region 115 it is surrounding by the liquid within the mixing chamber. The sensor set included in mixing element 150 sense one or more characteristics of mixing element 150.

The characteristics sensed by the sensor set of mixing element 150 are transmitted to a receiving device 170 deployed outside of interior region 115 via a wireless communication link 164 (shown as a dashed line). In some embodiments, wireless communications link 164 is a BlueTooth™ communication link. In other embodiments, wireless communications link 164 is near field communication link, such as, for example, an RFID communication link. Based upon the disclosure provided herein, one of ordinary skill in the art will recognize a variety of communication links and corresponding transmitter/receiver circuitry that may be used in relation to different embodiments.

In some embodiments, operation of the sensor set and/or transmitter/receiver circuitry within mixing element 150 may be configured by a control system 175 via a wireless communication link 168 (shown as a dashed line). Wireless communication link 168 may be the same as wireless communication link 164. In such embodiments, a configuration command may be transmitted via wireless communication link 168 by control system 175 to mixing element 150, and in turn a controller within mixing element 150 causes configuration of the sensor set and/or transmitter/receiver circuitry within mixing element 150. In some embodiments, control system 175 and receiving device 170 are the same device. In such embodiments, wireless communication link 168 is eliminated.

Turning to FIG. 2A, a cut-away view of mixing element 150 is shown. As shown, mixing element 150 includes a housing 201 surrounding an interior region 203. In some embodiments, housing 201 housing is a metal housing. Based upon the disclosure provided herein, one of ordinary skill in the art will recognize a variety of different materials that may be used to form housing 201.

A sensor set 205, a controller 210, a wireless transceiver 215, and a battery 220 (shown in FIG. 2B) are disposed within interior region 203. Sensor set 205 includes at least one sensor and may include any number of sensors. Sensor set 205 may include, but are not limited to, at least one of: a temperature sensor, a pressure sensor, and/or a movement sensor. A set of characteristics sensed by sensor set 205 include at least one characteristic and may include any number of characteristics. The set of characteristics may include, but are not limited to, at least one of a temperature of the liquid within the mixing chamber, pressure within the mixing chamber, and/or an acceleration of the mixing element.

In some embodiments, all of the sensors in the sensor set are deployed completely within housing. Thus, for example, where only a temperature and/or movement sensor are included, the sensors may be completely within housing 201 and still able to sense conditions outside of housing 201. In other embodiments, some portion of one or more sensors of sensor set 205 may extend to an outer surface of housing 201. As an example, a pressure sensor may have some circuitry deployed within housing 201, and a pressure transducer mounted on, connected to, or integrated with housing 201 such that the transducer is in contact with the environment surrounding housing 201. In such a case, a portion of sensor set 205 within housing 201 may be electrically connected to a transducer outside of housing 201. Based upon the disclosure provided herein, one of ordinary skill in the art will recognize a variety of sensors that may be included in sensor set 205 where either part or all of the sensors are deployed within housing 201 and in some cases a part may extend to an outer surface of housing 201.

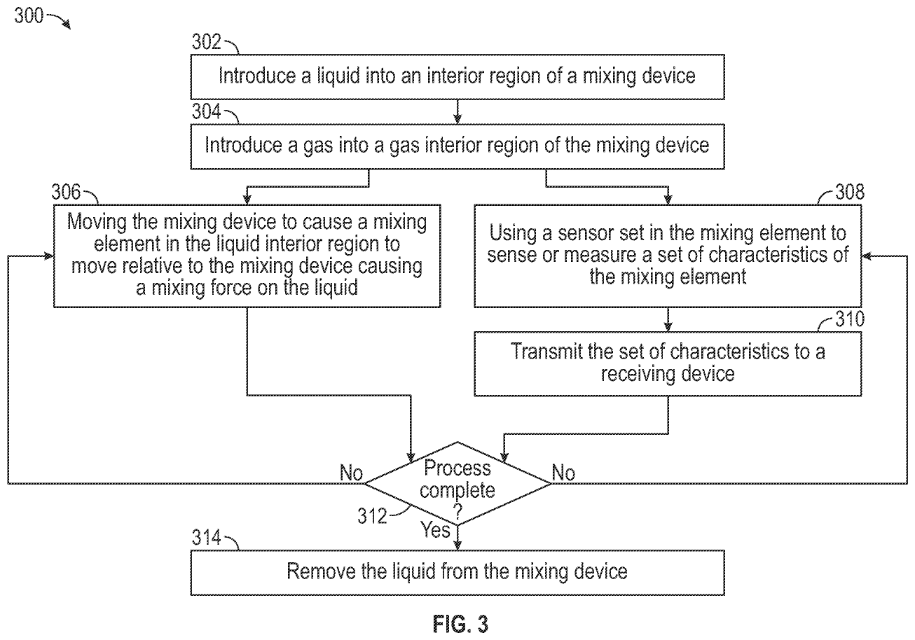

Controller 210 is configured to control operation of the sensors in sensor set 205, configuration of the sensors in sensor set 205, and/or receiving and transmitting data via wireless transceiver 215. In some embodiments, the sensors in sensor set 215 are pre-configured and do not need updates to their configuration and wireless transceiver 215 is a simple transmitter that transmits whenever one of the sensors in sensor set 205 indicates a new measurement. In such an embodiment, controller 210 may be a relatively simple circuit that merely transfers measurement data from the sensors in sensor set 205 to wireless transceiver. In such an embodiment, control system 175 may be eliminated. In other embodiments, the sensors in sensor set 205 are reconfigurable. In such embodiments, controller 210 may include a processor configured to receive a configuration command from control system 175 via wireless transceiver 215, and to configure operation of the sensors based upon the received configuration command. In such an embodiment, controller 210 may execute machine executable instructions maintained in a memory included in controller 210. Based upon the disclosure provided herein, one of ordinary skill in the art will recognize a variety of circuits and/or processors that may be used to implement controller 210 in accordance with different embodiments. In some embodiments, controller 210 controls performance of one or more of the processes discussed below in relation to FIGS. 3 and 6.

Wireless transceiver 215 may be any circuit known in the art that is capable of transmitting and/or receiving communications wirelessly. In some embodiments, wireless transceiver 215 is configured to support communications using a BlueTooth™ communication protocol. In other embodiments, wireless transceiver 215 is configured to perform near field communications. In some embodiments, performing such near field communications may include supporting an RFID communication profile. Based upon the disclosure provided herein, one of ordinary skill in the art will recognize a variety of communication circuits that may be used for wireless transceiver 215 and/or communication protocols that may be supported by wireless transceiver 215 in relation to different embodiments.

Battery 220 may be any battery known in the art. In some embodiments, battery 220 is a rechargeable battery that may be wirelessly recharged. Such wireless recharging provides for recharging battery 220 without unsealing housing 201 of mixing element 150. In some cases, battery 220 may be recharged without removing mixing element 150 from interior region 115 by moving mixing device 100 within a charging field. Based upon the disclosure provided herein, one of ordinary skill in the art will recognize a variety of batteries and/or recharging processes that may be used in relation to different embodiments. In some embodiments, housing 201 is permanently sealed such that sensor set 205, controller 210, wireless transceiver 215, and battery 220 are not accessible without destroying mixing element.

Turning to FIG. 2B, a block diagram of mixing device 150 is shown in relation to receiving device 17 and control system 175 in accordance with some embodiments. As shown, battery 220 provides power for sensor set 205, controller 210, and wireless transceiver 215. Controller 210 is communicably coupled to both sensor set 205 and wireless transceiver 215. Wireless transceiver 215 is communicably coupled to receiving device 170 via a wireless communication link 164 (represented as a dashed line), and to control system 175 via a wireless communication link 168 (represented as a dashed line).

Receiving device 170 includes a controller includes a wireless receiver 217 configured to receive wireless transmissions from wireless transceiver 215. As such, wireless receiver 271 is configured to communicate using a wireless communication protocol supported by controller 272. Controller 272 is communicatively coupled to wireless receiver 271, a memory 274, a display 276, and a user interface 278.

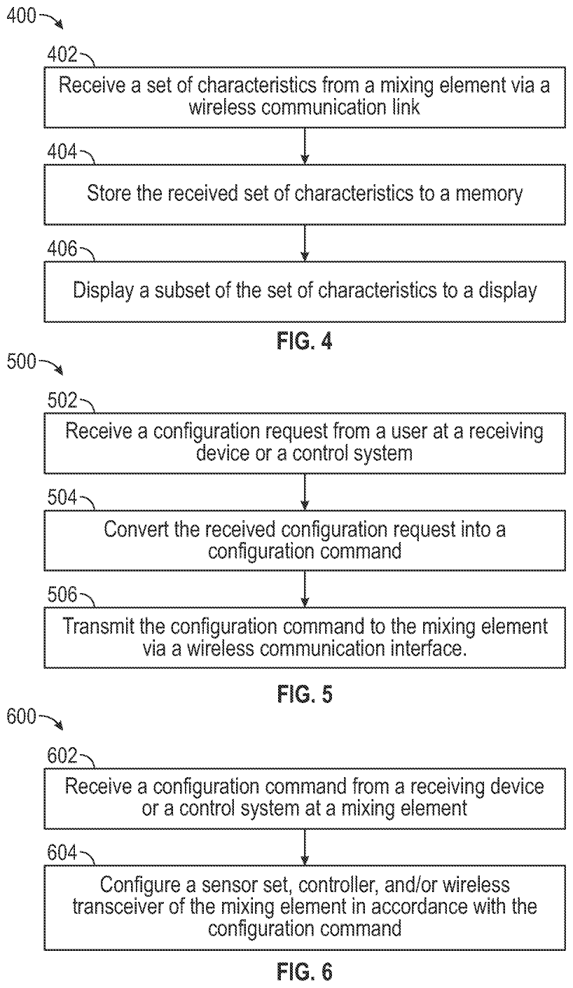

Memory 274 is configured to store information generated by mixing element 150 and received via communication link 264. In addition, memory 274 may store instructions executable by controller 272 to control one or more processes of receiving device 170. In some embodiments, controller 272 controls performance of one or more of the processes discussed below in relation to FIGS. 4 and 5. Memory 274 may be any type of non-transitory medium. In some embodiments, memory 274 includes a combination of dynamic random access memory and flash random access memory as are known in the art. Based upon the disclosure provided herein, one of ordinary skill in the art will recognize a variety of memory types that may be used in relation to different embodiments.

Display 276 may be any display known in the art that provides for displaying information to a user of receiving device 170. User interface 278 may be any interface known in the art that supports input from a user of receiving device 170. In some embodiments, user interface 278 is a touch screen integrated with display 276. Based upon the disclosure provided herein, one of ordinary skill in the art will recognize a variety of displays and/or user interfaces that may be incorporated into or communicatively attached to receiving device 170 that may be used in relation to different embodiments.

Controller 272 may be configured to control operations of receiving device including, but not limited to, receiving information from mixing element 150, storing the received information to memory 274, and displaying some form of the received information via display 276. In some embodiments, controller 272 may be a processor configured to execute instructions accessed from memory 274.

Turning to FIG. 3, a flow diagram 300 shows a method in accordance with some embodiments for monitoring one or more characteristics of a mixing element within a mixing device while the liquid is being mixed using a mixing element. Following flow diagram 300, a liquid is introduced into a liquid designated interior region of a mixing device (block 302). This may include, for example, opening a liquid port of the mixing device and flowing or injecting a liquid into the mixing device via the liquid port. In some cases, the liquid comprises a hydrocarbon containing liquid such as, but not limited to, oil.

A gas is introduced into a gas designated interior region of the mixing device (block 304). The gas is introduced at a desired pressure. The gas designated interior region is coupled to the liquid designated interior region such that the introduced gas does not mix with the introduced liquid, and the pressure in the liquid designated interior region is substantially the same as the pressure in the gas designated interior region.

The mixing device is moved to cause the mixing element within the liquid designated interior region to move relative to the mixing device (block 306). A combination of the movement of the mixing device and the mixing element causes a mixing force on the liquid within the liquid designated liquid region. This movement may be continued over a period of time where the mixing device is heated using a heater.

As the mixing process is performed (block 306), a sensor set in the mixing element is used to sense or otherwise measure a set of characteristics of the mixing element (block 308). As the mixing element is surrounded by the liquid in the liquid designated interior region, the characteristics of the mixing element are reasonably representative of corresponding characteristics of the liquid. In some embodiments, the sensor set includes, but are not limited to, at least one of a temperature sensor and/or a movement sensor. In such embodiments, the set of characteristics sensed by the sensor set include at least one of a temperature of the liquid within the mixing chamber and/or an acceleration of the mixing element.

At either designated time intervals or upon an update of a sensed characteristic, the set of characteristics are transmitted to a receiving device (block 310). Such transmission may be done via a wireless transmitter within the mixing element to a receiving device maintained outside of the liquid designated interior region. In some embodiments, the wireless communications are done using a BlueTooth™ communication protocol. In other embodiments, the wireless communications are done using a near field communication protocol, such as, for example, an RFID communication protocol. Based upon the disclosure provided herein, one of ordinary skill in the art will recognize a variety of communication protocols that may be used in relation to different embodiments.

It is determined whether the process using the mixing device has been completed (block 312). Where the process has not yet completed (block 312), the processes of blocks 306-310 are continued. Otherwise, where the process has been completed (block 312), the liquid is removed from the mixing device by opening the liquid port and allowing the liquid to drain (block 314).

Turning to FIG. 4, a flow diagram 400 shows a method in accordance with various embodiments for processing data received from a mixing element within a mixing device while a liquid is being mixed in the mixing device. Following flow diagram 400, a set of characteristics are received from a mixing device via a wireless communication link (block 402). In some embodiments, the wireless communication link is a BlueTooth™ communication link. In other embodiments, the wireless communication link is a near field communication link, such as, for example, an RFID communication link. Based upon the disclosure provided herein, one of ordinary skill in the art will recognize a variety of communication links that may be used in relation to different embodiments. In various embodiments, the set of characteristics sensed by the sensor set include at least one of a temperature of the mixing element within a mixing chamber of a mixing device and/or an acceleration of the mixing element. Based upon the disclosure provided herein, one of ordinary skill in the art will recognize a variety of characteristics that may be received in relation to different embodiments.

The received set of characteristics are stored to a memory on the receiving device (block 404), and a set of information derived from the set of characteristics are displayed via a display in the receiving device (block 406).

Turning to FIG. 5, a flow diagram 500 shows a method in accordance with some embodiments for configuring a mixing element. The method is shown from the perspective of a receiving device or control system. Following flow diagram 500, a configuration request is received from a user (block 502). This configuration request may be received from, for example, a control system or receiving device that is capable of communicating a configuration command to a mixing element to be configured. As an example, the configuration request may be received via user interface 278 of receiving device 170. Based upon the disclosure provided herein, one of ordinary skill in the art will recognize a variety of mechanisms and/or devices that may be used to receive a configuration request from a user. As one example, the configuration request may be a pre-programmed static request that is automatically used by a device in communication with the mixing element.

The configuration request may include one or more parameters to be used by the mixing element. In some embodiments, the configuration request indicates a frequency at which measurements are to be made by one or more sensors included in a set of sensors in the mixing element, and/or a frequency at which any measurements sensed by the mixing element are to be transmitted to a receiving device. In some embodiments, the configuration request indicates a variety of alarm conditions that should be determined by the mixing element and immediately transmitted to the receiving device. Such alarm condition may include, but are not limited to, an under-temperature condition occurring when a temperature measured by the mixing element is less than a first programmable threshold, an over temperature condition occurring when a temperature measured by the mixing element exceeds a second programmable threshold, a low battery condition occurring when a charge on the battery of the mixing element is less than a third programmable threshold. Based upon the disclosure provided herein, one of ordinary skill in the art will recognize a variety of configuration parameters that may be requested by a user in accordance with different embodiments.

The received configuration request is converted to a configuration command that may be interpreted by the mixing element (block 504). This configuration command is transmitted to the mixing element via a wireless communication link (block 506). In turn, the mixing element configures itself to operate in accordance with the configuration command.

Turning to FIG. 6, a flow diagram 600 shows a method in accordance with some embodiments for configuring a mixing element. The method is shown from the perspective of the mixing element. Following flow diagram 600, a configuration command is received from either a control system or a receiving device (block 602). The configuration command is received via a wireless communication link supported by a wireless transceiver within the mixing element.

The configuration command includes one or more instructions related to the desired operation of the mixing element receiving the configuration command and is received via wireless communication link. In some embodiments, the configuration command indicates a frequency at which measurements are to be made by one or more sensors included in a set of sensors in the mixing element, and/or a frequency at which any measurements sensed by the mixing element are to be transmitted to a receiving device. In some embodiments, the configuration command indicates a variety of alarm conditions that should be determined by the mixing element and immediately transmitted to the receiving device. Such alarm condition may include, but are not limited to, an under-temperature condition occurring when a temperature measured by the mixing element is less than a first programmable threshold, an over temperature condition occurring when a temperature measured by the mixing element exceeds a second programmable threshold, a low battery condition occurring when a charge on the battery of the mixing element is less than a third programmable threshold. Based upon the disclosure provided herein, one of ordinary skill in the art will recognize a variety of configuration parameters that may be provided to the mixing element and used by the mixing element for configuration in accordance with different embodiments.

In response to the received configuration command (block 602), the sensor set, the controller, and/or the wireless transceiver of the mixing element are configured (block 604). Once configured (block 604), operation of the mixing element proceeds in accordance with the configuration. Based upon the disclosure provided herein, one of ordinary skill in the art will recognize a variety of processes that may be used to configure the mixing element in accordance with different embodiments.

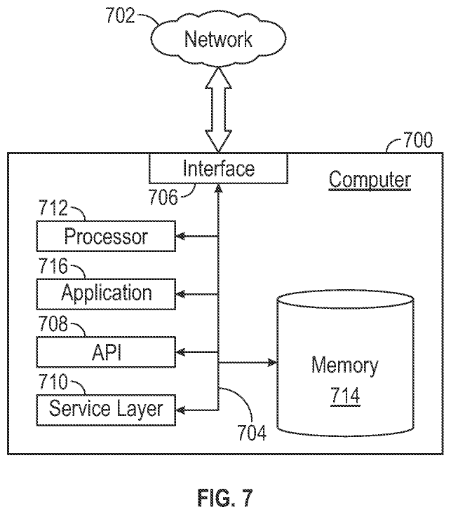

One or more embodiments may be implemented using a computer system. For example, receiving device 170 and/or control system 175 may be implemented as an application running on a computer system. FIG. 7 is a block diagram of a computer system 700 used to provide computational functionalities associated with described algorithms, methods, functions, processes, flows, and procedures as described in the instant disclosure, according to an implementation. Computer system 700 is one example of a large number of computer systems that may be used to implement different embodiments. Based upon the disclosure provided herein, one of ordinary skill in the art will recognize a wide variety of computer systems that may be used in relation to different embodiments.

Computer system 700 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, computer system 700 may include a computer that includes an input device, such as a keypad, keyboard, touch screen, or other device that can accept user information, and an output device that conveys information associated with the operation of computer system 700, including digital data, visual, or audio information (or a combination of information), or a GUI.

Computer system 700 can serve in a role as a client, network component, a server, a database or other persistency, or any other component (or a combination of roles) of a computer system for performing the subject matter described in the instant disclosure. Computer system 700 is communicably coupled with a network 702. In some implementations, one or more components of computer system 700 may be configured to operate within environments, including cloud-computing-based, local, global, or other environment (or a combination of environments).

At a high level, computer system 700 is an electronic computing device operable to receive, transmit, process, store, or manage data and information associated with the described subject matter. According to some implementations, computer system 700 may also include or be communicably coupled with an application server, e-mail server, web server, caching server, streaming data server, business intelligence (BI) server, or other server (or a combination of servers).

Computer system 700 can receive requests over network 702 from a client application (for example, executing on another computer system (not shown) and responding to the received requests by processing the said requests in an appropriate software application. In addition, requests may also be sent to computer system 700 from internal users (for example, from a command console or by other appropriate access method), external or third-parties, other automated applications, as well as any other appropriate entities, individuals, systems, or computers.

Each of the components of computer system 700 can communicate using a system bus 704. In some implementations, any or all of the components of the computer system 700, both hardware or software (or a combination of hardware and software), may interface with each other or interface 706 (or a combination of both) over system bus 704 using an application programming interface (API) 708 or a service layer 710 (or a combination of API 708 and service layer 710. API 708 may include specifications for routines, data structures, and object classes. API 708 may be either computer-language independent or dependent and refer to a complete interface, a single function, or even a set of APIs. Service layer 710 provides software services to computer system 700 or other components (whether or not illustrated) that are communicably coupled to computer system 700. The functionality of computer system 700 may be accessible for all service consumers using this service layer. Software services, such as those provided by service layer 710, provide reusable, defined business functionalities through a defined interface. For example, the interface may be software written in JAVA, C++, or other suitable language providing data in extensible markup language (XML) format or other suitable format. While illustrated as an integrated component of computer system 700, alternative implementations may illustrate API 708 or service layer 710 as stand-alone components in relation to other components of computer system 700 or other components (whether or not illustrated) that are communicably coupled to computer system 700. Moreover, any or all parts of API 708 or service layer 710 may be implemented as child or sub-modules of another software module, enterprise application, or hardware module without departing from the scope of this disclosure.

Computer system 700 includes an interface 706. Although illustrated as a single interface 706 in FIG. 7, two or more interfaces 706 may be used according to particular needs, desires, or particular implementations of computer system 700. Interface 706 is used by computer system 700 for communicating with other systems in a distributed environment that are connected to the network 702. Generally, the interface 706 includes logic encoded in software or hardware (or a combination of software and hardware) and operable to communicate with the network 702. More specifically, the interface 706 may include software supporting one or more communication protocols associated with communications such that the network 702 or interface's hardware is operable to communicate physical signals within and outside of the illustrated computer system 700.

Computer system 700 includes at least one computer processor 712. Although illustrated as a single computer processor 712 in FIG. 7, two or more processors may be used according to particular needs, desires, or particular implementations of computer system 700. Generally, the computer processor 712 executes instructions and manipulates data to perform the operations of computer system 700 and any algorithms, methods, functions, processes, flows, and procedures as described in the instant disclosure.

Computer system 700 also includes a memory 714 that holds data for computer system 700 or other components (or a combination of both) that may be connected to the network 702. For example, memory 714 may be a database storing data consistent with this disclosure. Although illustrated as a single memory 714 in FIG. 7, two or more memories may be used according to particular needs, desires, or particular implementations of computer system 700 and the described functionality. While memory 714 is illustrated as an integral component of computer system 700, in alternative implementations, memory 714 may be external to computer system 700.

In addition to holding data, the memory may be a non-transitory medium storing computer readable instruction capable of execution by computer processor 712 and having the functionality for carrying out manipulation of the data including mathematical computations.

Application 716 is an algorithmic software engine providing functionality according to particular needs, desires, or particular implementations of computer system 700, particularly with respect to functionality described in this disclosure. For example, application 716 can serve as one or more components, modules, applications, etc. Further, although illustrated as a single application 716, application 716 may be implemented as multiple applications 716 on computer system 700. In addition, although illustrated as integral to computer system 700, in alternative implementations, application 716 may be external to computer system 700.

There may be any number of computers 700 associated with, or external to, a computer system containing computer system 700, each computer system 700 communicating over network 702. Further, the term “client,” “user,” and other appropriate terminology may be used interchangeably as appropriate without departing from the scope of this disclosure. Moreover, this disclosure contemplates that many users may use one computer system 700, or that one user may use multiple computers 700.

In some embodiments, computer system 700 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A sample mixing apparatus, the apparatus comprising:
a mixing element having a first volume, the mixing element comprising:
a sealed first housing having a first interior region;
a sensor set disposed in the first interior region and configured to sense a set of characteristics of the mixing element; and
a wireless transmitter disposed in the first interior region and configured to communicate the set of characteristics;
a mixing chamber comprising:
a second housing surrounding a second interior region, wherein the mixing element is disposed in the second interior region, wherein the second interior region has a second volume, and wherein the second volume is greater than the first volume; and
a liquid port configured to transmit the liquid into the second interior region.

2. The apparatus of claim 1, wherein the sensor set comprises at least one of: a temperature sensor and a movement sensor; and wherein the set of characteristics comprises at least one of a temperature and an acceleration.

3. The apparatus of claim 1, wherein the sensor set comprises at least one of: a temperature sensor, a movement sensor, and a pressure sensor.

4. The apparatus of claim 1, wherein moving the second housing causes movement of the mixing element relative to the second housing and produces a mixing action on the liquid.

5. The apparatus of claim 1, wherein the liquid comprises a hydrocarbon containing liquid.

6. The apparatus of claim 5, wherein the hydrocarbon containing liquid comprises oil.

7. The apparatus of claim 1, wherein the first housing is a spherical shape.

8. The apparatus of claim 7, wherein the second interior region is a cylindrical shape, and wherein a diameter of the spherical shape is less than eighty-percent of a diameter of the cylindrical shape.

9. The apparatus of claim 1, wherein the second interior region is a cylindrical shape.

10. The apparatus of claim 1, wherein the wireless transmitter transmits the set of characteristics less than ten meters from the mixing element.

11. The apparatus of claim 1, wherein the wireless transmitter is part of a wireless transceiver, and wherein the wireless transceiver further comprises: a wireless receiver configured to receive a command to control the sensor set from a receiving device.

12. A method for processing a liquid, the method comprising:
introducing a liquid into a second interior region of a second housing via a liquid port, wherein a mixing element is deployed within the second interior region, and wherein the mixing element comprises:
a first housing surrounding a first interior region;
a sensor set disposed in the interior region and configured to sense a set of characteristics of a liquid adjacent the first housing;
a wireless transmitter configured to communicate the set of characteristics;
moving the second housing to cause the first housing to move within the second interior region mixing the liquid;
sensing, by the sensor set, a set of characteristics of the liquid surrounding; and
transmitting, by the wireless transmitter; the set of characteristics.

13. The method of claim 12, the method further comprising:
receiving, by a receiving device, the set of characteristics;
storing the set of characteristics to a memory; and
displaying at least a subset of the set of characteristics via a display.

14. The method of claim 13, wherein the receiving device is within ten meters of the mixing element.

15. The method of claim 12, wherein the sensor set comprises a temperature sensor, and wherein the set of characteristics comprises a temperature of the liquid.

16. The method of claim 15, wherein the sensor set further comprises at least one of: a temperature sensor, and a pressure sensor.

17. The method of claim 12, wherein the liquid comprises a hydrocarbon containing liquid.

18. The method of claim 17, wherein the hydrocarbon containing liquid comprises oil.

19. The method of claim 12, wherein the first housing is a spherical shape.

20. The method of claim 12, wherein the second interior region is a cylindrical shape.

21. The method of claim 12, wherein the wireless transmitter is part of a wireless transceiver, wherein the mixing element further comprises a controller communicably coupled to the wireless transceiver, and wherein the method further comprises:
receiving, by the controller via the wireless transceiver, a command from a receiving device, wherein the command indicates an operation of the set of sensors; and
configuring, by the controller, the set of sensors based upon the command.
